(19) United States
(12) Patent Application Publication
(10) Pub. No.: US 2023/0211448 A1
(43) Pub. Date: Jul. 6, 2023

(54) METHOD FOR CHECKING AT LEAST ONE SUBREGION OF A COMPONENT AND CHECKING DEVICE FOR CHECKING AT LEAST ONE SUBREGION OF A COMPONENT

(71) Applicant: MTU Aero Engines AG, Muenchen (DE)

(72) Inventors: Martin ECKSTEIN, Puchheim (DE); Daniel PFIRRMANN, Muenchen (DE); Martin BUßMANN, Schwabhausen (DE); Joachim BAMBERG, Dachau (DE)

(21) Appl. No.: 17/252,056

(22) PCT Filed: Jun. 18, 2019
(86) PCT No.: PCT/DE2019/000163

§ 371 Date: May 5, 2021

(30) Foreign Application Priority Data
Jun. 27, 2018 (DE) 10 2018 210 463.8

(51) Int. Cl. B23Q 17/09; G01N 3/40; G05B 19/418

(52) U.S. Cl. CPC B23Q 17/0961; G01N 3/40; G05B 19/41875; B23Q 2717/003; B23Q 2717/006; G01N 2203/0053; G01N 2203/0248; G05B 2219/32222

(57) ABSTRACT

A method for checking at least one subregion of a component, in particular a component of a turbomachine, including at least the steps of a) providing a blank; b) producing at least the subregion from the blank by machining the blank using at least one tool and using at least one force sensor-to record at least one force curve of at least one force acting during machining on the at least one tool; c) checking whether there is at least one deviation-of the at least one force curve from at least one predetermined target curve-of the at least one force curve, the at least one deviation-characterizing at least one material defect-contained in an unmachined segment of the subregion. A checking device for checking at least a subregion of a component is also provided.

The present invention relates to a method for checking at least one subregion of a component, in particular a component of a turbomachine. Another aspect of the present invention relates to a checking device for checking at least one subregion of a component.

### BACKGROUND

Undetected material defects in components can sometimes have devastating consequences, in particular in the case of components of turbomachines, such as aircraft engines. From the related art, it is known to subject components for detecting material defects to an ultrasonic test, for example, in order to detect material defects in the form of voids, for example. However, it can happen that some material defects in the component remain undetected by currently known ultrasonic test methods. For this reason, complex methods are often performed which include, for example, an etch test for detecting material defects in the form of segregations.

The term segregation refers to decomposition of a metal alloy melt at the transition of the melt into the solid state, which leads to a local increase and/or decrease of certain elements within the mixed crystal of the metal alloy. Therefore, the segregations cause locally different material properties within a component. For example, “dirty white spots” are known in components of turbomachines, such as engine disks made of nickel-based alloys, which can lead during operation of the engine to cracking, culminating in failure of the component due to long-term low cycle fatigue loads. The term “low cycle fatigue” is also known by the designation low-load alternation fatigue.

### SUMMARY OF THE INVENTION

It is an object of the present invention to provide a method of the type mentioned at the outset, which makes possible a low-expenditure checking of material defects contained inside of a component. Another object of the present invention is to provide a checking device for checking material defects contained inside of a component.

The present invention provides a method, as well as a checking device.

A first aspect of the present invention relates to a method for checking at least a subregion of a component, in particular of a component of a turbomachine. The method includes at least the steps of:

a) providing a blank;

b) producing at least the subregion from the blank by machining the blank using at least one tool and using at least one force sensor to record at least one force curve of a force acting during machining on the at least one tool;

c) checking whether there is at least one deviation of the at least one force curve from at least one predetermined target curve of the at least one force curve, the at least one deviation characterizing at least one material defect contained in an unmachined segment of the subregion. The target curve can likewise characterize the machining of the subregion. It is clear that the method also makes it possible to detect a plurality of material defects, which can also be referred to as faults. Overall, therefore, the method makes possible a quality check in the course of (thus, during) the machining, which may also be referred to as machine cutting. The method makes it possible for a number of faults to be detected, for example, during machine cutting when at least the subregion is produced from the blank, whereby an especially informative evaluation of a component quality may be made. Independently thereof, the method makes it possible to detect a size of the defect, respectively of the defects, for example, during machine cutting when at least the subregion is produced from the blank, whereby the component quality may be assessed very accurately. Independently thereof, the method makes it possible to detect a position of the defect, respectively of the defects, for example, during machine cutting when at least the subregion is produced from the blank, especially accurate information about the component quality being thereby provided. Generally, the at least one material defect may be spaced at a distance from the tool and contained in the blank component (within the blank component) during implementation of step b). A particular advantage of the method is that the subregion may be produced (step b), and the force curve determined during this time, the force curve being used in step c) during checking. Thus, the machining and the detection of the force curve used for the checking in step c) may be parallelized and consequently time saved, making it altogether possible for the checking to be performed very economically. Parallelizing steps b) and c) makes it possible for the checking to be performed, so to speak, as an “online diagnosis” during machining, that is to say machine cutting. The component may be in the form of a forged component, for example. Within the scope of the present invention, the term “material defect” is to be understood as a defective partial volume of the blank component, respectively of the subregion.

The at least one deviation may preferably characterize at least a segregation as the at least one material defect. This is especially beneficial since it eliminates the need for a related art checking that involves destruction of the component. Instead, the method makes possible detection of the material defect in the form of segregation.

Prior to the provision thereof in accordance with step a), the blank may be subjected to an ultrasonic test. If serious defects, respectively material defects are already ascertained during the ultrasonic test, the blank may be immediately declared to be scrap and replaced by another blank, making it possible to save time.

In an advantageous embodiment of the present invention, step c) is implemented during the production of the at least one subregion from the blank in accordance with step b). This is advantageous since steps b) and c) may thus be implemented without the machining having to be interrupted during checking or the checking having to be delayed until completion of the machining. Overall, therefore, both the production of the subregion as well as the checking may thereby be executed at least substantially simultaneously, resulting in a significant time savings.

In another advantageous embodiment of the present invention, the at least one force curve is compared in step c) to the at least one further force curve, which characterizes a machining of at least one further component, and the at least one deviation in the at least one subregion is thereby evaluated, the at least one further component having at least one further material defect that is substantially identical to the at least one material defect, and at least one further deviation of the at least one further force curve from the at least one predetermined target curve being present. This is advantageous since an especially informative evaluation of the material defect may be made on the basis of the at least one further force curve (of the at least one further component). To evaluate the at least one material defect, a plurality of further force curves of a corresponding plurality of further components may preferably be used, making possible a statistically validated evaluation. During the “evaluation,” it may be analyzed, for example, whether the at least one material defect is so serious that the component is regarded as scrap or whether the at least one material defect is tolerable and the component thus suited for the normal intended use thereof. The further component may be produced before the component and, in this case, also be referred to as a historical component. The further component may have been subject to the machining using the same or at least a substantially identical tool. Due to the fact that the further component has the substantially identical, further material defect, in the case of the further component, there is a contamination by the further material defect. The further component may thereby be contaminated by the at least one, substantially identical further material defect. The method according to the present invention may be used to produce the further component from a further blank having the further force curve, and the further force curve thereby ascertained. The component and the further component may be respective, substantially identical engine disks, turbine disks or blisks, for example, which are each produced by the method.

Another advantageous embodiment of the present invention provides that a position of the at least one material defect in the unmachined segment be determined at least approximately by comparing the at least one force curve with the at least one further force curve. This is advantageous since, during normal intended use of the component, it makes it hereby possible to determine, for example, whether the material defect is located in a high-load component region or in a low-load component region. If the material defect is located in the highly stressed component region, the component may then be evaluated to be scrap, in other words unsuited for normal intended use. If the material defect is in the low-load component region, the component may be evaluated to be tolerable, thus suited for intended use. Thus, as the case may be, at least approximately determining the position makes it possible to avoid unnecessarily designating the component as scrap.

In another advantageous embodiment of the present invention, the at least one deviation in the at least one subregion is evaluated using at least one gradient of the at least one force curve and/or of the at least one further force curve. This is advantageous since the force gradient may be used, for example, to evaluate material defect parameters characterizing the material defects, such as a hardness, a brittleness and/or a size of the material defect. This helps ensure a more accurate evaluation of the material defect. In this regard, the gradients of the at least one force curve and of the at least one further force curve may be mutually compared. This makes it possible to determine differences between the respective force gradients and infer the material defect parameters.

In another advantageous embodiment of the present invention, the at least one force gradient of the at least one force curve and/or of the at least one further force curve is time-dependent and/or location-dependent. This is advantageous since a location dependence, respectively time-dependence of the force gradient is hereby used, whereby an especially informative checking may be implemented. If the force gradient is time-dependent and location-dependent, then a velocity dependence of the force gradient may be used.

In another advantageous embodiment of the present invention, at least one change in the at least one force gradient effected by the layer-by-layer material removal from the blank during machining is used in order to evaluate the at least one deviation. This is advantageous since it makes it possible, for example, to hereby evaluate the distance between the material defect and a surface of the blank machined by the tool. The distance may also be referred to as the depth at which the material defect lies. When material is removed layer-by-layer from the blank during machining, the material defect present in the blank may be passed over multiple times, it being possible for a material defect volume of the material defect to be evaluated, for example, on the basis of the change in the force curve. The material defect volume may characterize a spatial extent of the material defect. This makes it possible to reliably evaluate whether or not the material defect is tolerable.

In another advantageous embodiment of the present invention, the at least one further force curve is determined before the at least one force curve. This is advantageous since, within the scope of the method, the at least one further force curve may thus be made available at least as part of an empirical data set already before the at least one force curve is determined, which may help ensure that the entire method is performed more rapidly.

In another advantageous embodiment of the present invention, the checking is implemented in step c) using an artificial neural network, in particular a deep learning method. Artificial neural networks are networks of artificial neurons and are especially well suited for checking the deviation. In deep learning, a computer model is trained how to perform classification tasks directly from the deviation or from a plurality of deviations. If indicated, the deep learning model used may first be trained on the basis of extensive sets of classified data and on the basis of neural network architectures.

In another advantageous embodiment of the present invention, the at least one cutting force, which acts during machining on the at least one tool, is used as the at least one force. This is advantageous since the cutting force makes possible an especially reliable checking as to whether the deviation is present. Moreover, the cutting force results from a direct contact of the tool, respectively of at least one cutting edge of the tool with the blank during machining, making it possible to at least substantially prevent disturbances.

Another advantageous embodiment of the present invention provides that a milling cutter or a lathe tool be used as the at least one tool. This is advantageous because a milling cutter or a turning tool not only makes possible an especially accurate machining, but also an especially low-expenditure recording of the force curve. The milling cutter may be an end milling cutter, for example, and the turning tool a lathe tool, for example.

A second aspect of the present invention relates to a checking device for checking at least a subregion of a component, in particular a component of a turbomachine. Upon production of the at least one subregion from a blank by machining the blank using at least one tool, the checking device is adapted for receiving force-curve sensor signals, which characterize at least one force curve of at least one force acting on the at least one tool during the machining, from at least one force sensor. Moreover, on the basis of the force-curve sensor signals, which characterize the at least one force curve, the checking device is adapted for checking whether there is at least one deviation of the at least one force curve from at least one predetermined target curve of the at least one force curve, the at least one deviation characterizing at least one material defect contained in an unmachined segment of the subregion. The checking device according to the present invention thus makes possible a low-expenditure checking of material defects contained inside of a component. The checking device may have a processor device, which is at least composed of a microprocessor and/or of a microcontroller. Moreover, the processor device may have program code which, when executed by the same, is adapted for implementing at least a few steps of the method or at least a specific embodiment of the method in accordance with the first inventive aspect. The program code may be stored in a data store coupled to the processor device. The checking device may include the at least one force sensor, the processor device, for example, also being able to be receive and analyze the force-curve sensor signals. The checking device may also include the at least one tool. Moreover, the checking device may also include a driving device for operating the tool. The driving device is able to drive and control the machining tool. The features presented in the context of the inventive method in accordance with the first aspect of the present invention as well as the advantages thereof apply analogously to the inventive checking device in accordance with the second aspect of the present invention, and vice versa.

In an advantageous embodiment of the present invention, the checking device includes a display device for displaying the at least one deviation of the at least one force curve from the at least one predetermined target curve. The entire checking device is preferably portable, preferably separately powered, so that at least the receiving of the force-curve sensor signals, the checking on the basis of the force curve, and the displaying of at least the deviation may take place directly on the component without additional aids.

### BRIEF DESCRIPTION OF THE DRAWINGS

Other features of the present invention will become apparent from the claims, the figures, and the detailed description. The features and feature combinations mentioned above in the description, as well as the features and feature combinations mentioned below in the detailed description and/or shown in isolation in the figures may each be used not only in the indicated combination, but also in other combinations, without departing from the scope of the present invention. Thus, embodiments of the present invention that are not explicitly shown and explained in the figures, but derive from and can be produced from the explained embodiments on the basis of separate feature combinations, are also considered to be included and disclosed herein. In addition, embodiments and combinations of features which, therefore, do not have all of the features of an originally formulated independent claim are also considered to be disclosed. Moreover, variants and feature combinations, which go beyond or deviate from the feature combinations described in the antecedent references to the claims, are also considered to have been disclosed, in particular by the above explanations. In the drawing,

FIG. 1 is a schematic representation of a component for a turbomachine as well as of a blank, from which at least a subregion of the component may be produced by machining;

FIG. 2 is a cutaway view of the subregion of the component being produced by machining by a tool in the form of a milling cutter, a schematically illustrated checking device implementing a checking for material defects in an unmachined segment of the subregion; and

FIG. 3 is a diagram showing a force curve of a force acting on the tool during machining, a predetermined target curve of the at least one force curve as well as various deviations of the force curve from the target curve, the deviations characterizing various material defects contained in the unmachined segment of the subregion.

### DETAILED DESCRIPTION

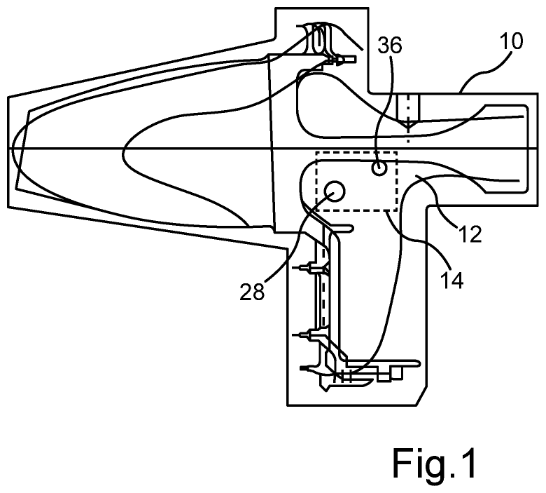

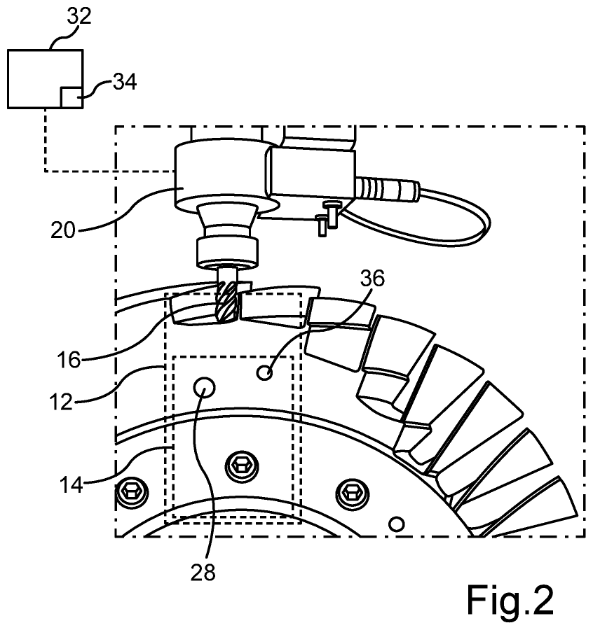

FIG. 1 schematically shows a blank 10 which has a blank outer contour. The outer contour of the blank is an outer contour of blank 10 prior to a machining by a tool 16 in the form of a milling cutter, which is shown exemplarily in FIG. 2.

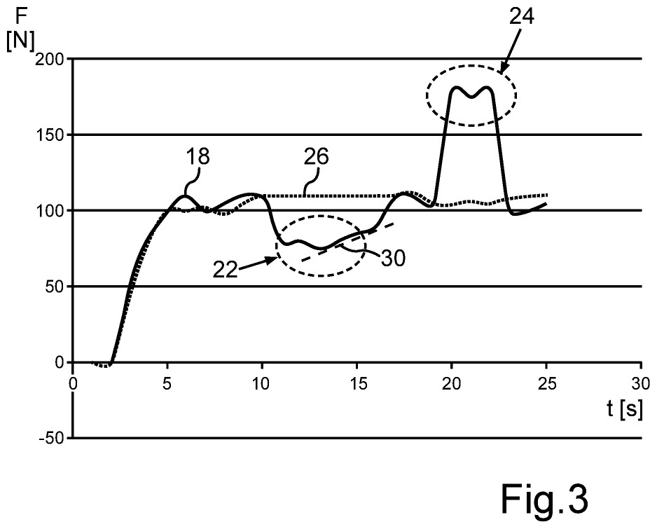

FIG. 2 illustrates exemplarily a method for checking at least one subregion 12 of a component of a turbomachine that is shown in FIGS. 1 and 2, where, in a step a), blank 10 is first provided. In a step b), at least subregion 12 is produced from blank 10 by the machining of blank 10 using tool 16, and at least one force sensor 20 records force curve 18 of at least one force acting during the machining on the at least one tool 16. In step c), a checking takes place as to whether there are deviations 22, 24 of the at least one force curve 18 from at least one predetermined target curve 26 of the at least one force curve 18, deviations 22, 24 characterizing specific material defects 28, 36 contained in an unmachined segment 14 of subregion 12. Force curve 18, target curve 26 as well as deviations 22, 24 are exemplarily illustrated in a diagram shown in FIG. 3. In the diagram shown in FIG. 3, force values in [N] are plotted on an ordinate axis and time values in [s] on an abscissa axis. At least one cutting force, which acts during machining on the at least one tool 16, is used as the at least one force. Depending on whether tool 16 is in the form of a milling cutter or lathe tool, the cutting force may be composed of a plurality of cutting force components, which may include a feed force, a passive force and (in the case of the milling cutter) a normal feed force. In FIG. 3, the force values plotted on the coordinate axis are specific to the passive force.

In the present case, deviation 22 characterizes material defect 28, whereas deviation 24 characterizes material defect 36. Here, material defect 28 is in the form of a segregation or void and thus constitutes a relatively soft microstructural region. In the present case, material defect 36 is in the form of a carbide accumulation and constitutes an especially hard microstructural region in comparison to material defect 28, as is discernible from force curve 18.

Step c) of the method is performed here during production of the at least one subregion 12 from blank 10 in accordance with step b). In step c), the at least one force curve 18 is compared with a plurality of further force curves (which are not specifically shown in FIG. 3 for the sake of clarity). The further force curves each characterize a machining of a plurality of further components (not shown in detail here). By comparing the at least one force curve 18 with the further force curves, it is possible to evaluate deviations 22, 24 in the at least one subregion, the further components each having at least one further material defect, which, in comparison to material defects 28, 36, is substantially identical, and respective further deviations of the further force curves from target curve 26 being present. The further force curves are determined before the at least one force curve 18.

The respective further force curves of the plurality of further force curves may be correlated with metallography data sets determined from a respective metallography of the further components of the plurality of further components and, additionally or alternatively, with low-cycle fatigue data sets determined from a respective low-cycle fatigue of the further components of the plurality of further components. The respective further force curves, the metallography data sets and/or the low-cycle fatigue data sets may be recorded in a material-defect cutting force database. The material-defect cutting force database may be used for checking subregion 12 and thus the component as well as for checking future components, which, like the component, may be checked on the basis of the method, respectively using checking device 32, to render possible an especially informative checking and reliable detection of segregations or other material defects. On the basis of the material-defect cutting force database, which may also be abbreviated as database, it is possible to statistically evaluate a probability of defects (material defects) occurring in subregion 12 and/or in the entire component, whereby especially accurate information about a quality of subregion 12, respectively of the component is made possible. This makes it possible for non-specification compliant material (scrap) to be detected and separated out at an early stage. The method may also be applied to other machining methods, which, besides milling, also include drilling and broaching, for example, and the statistical significance may thereby be further enhanced. For this purpose, the database may include further empirical data sets determined during machining by the various machining methods.

By comparing the at least one force curve 18 with the further force curves, it is possible to at least approximately determine a respective position of material defects 28, 36 in unmachined segment 14.

Deviations 22, 24 in the at least one subregion 12 are evaluated using respective force gradients of the at least one force curve 18 and, additionally or alternatively, of the further force curves. For the sake of clarity, FIG. 3 merely shows a force gradient 30 of the respective force gradients associated with the at least one force curve 18.

The respective force gradients of force curve 18 and, additionally or alternatively, of the further force curves are time-dependent here, as is discernible on the basis of force gradient 30 in FIG. 3.

To evaluate deviations 22, 24, at least one change in the at least one force gradient 30 effected by the layer-by-layer material removal from blank 10 during machining is used over time. If, for example, during the layer-by-layer material removal, material defect 28 in the form of a segregation or void is passed over multiple times, characteristic cutting force curve 18 results, which may be evaluated and analyzed in a positionally accurate (spatially resolved) manner.

In step c), an artificial neural network, in particular a deep learning method is performed to implement the checking. The artificial neural network thereby includes respective data sets characterizing the further force curves as respective parts of an empirical data set, whereby training may be initiated. The artificial neural network may be trained, for example, on the basis of the material-defect cutting force database. Overall, therefore, the data sets, which characterize the further force curves, form an empirical data set. The material-defect cutting force database may include the empirical data set.

In greatly simplified form, FIG. 2 shows a checking device 32 for checking subregion 12. Checking device 32 is adapted for recording the at least one force curve 18 of the force acting during the machining on tool 16 during production of subregion 12 from blank 10 by the machining thereof by tool 16, by the checking device receiving force-curve sensor signals, which characterize force curve 18, from force sensor 20. In addition, checking device 32 is adapted for checking whether there are deviations 22, 24 of force curve 18 from predetermined target curve 26 of force curve 18 on the basis of the force-curve sensor signals characterizing the at least one force curve 18.

The feed force, the passive force and the normal feed force may be recorded separately from one another with the aid of force sensor 20 and digitized as time series, for example, at a sampling rate within the range of from 20 to 40 kHz, thus transmitted as the force-curve sensor signals to checking device 32 or to a processor device (not shown) of checking device 32.

In addition, checking device 32 includes a display device 34 for displaying the at least one deviation 22, 24 of the at least one force curve 18 from the at least one predetermined target curve 26.

The present method as well as the present checking device 32 make it possible to detect defects, in particular in the form of segregations, as in the present example of material defects 28. This eliminates the need for a costly and time-consuming etch test.

The method, respectively checking device 32 makes it possible for a volume of blank 10, respectively of the component and thus also of subregion 12, which is to be machine-cut during machining, to be evaluated by dynamic cutting force measurement (in which corresponding force curve 18 is determined) with regard to the occurrence, for example, of the segregation (material defect 28) or with regard to an occurrence of a plurality of segregations, it being possible, for example, for a size, a position and, additionally or alternatively, a brittle behavior of the individual segregations to be evaluated.

In comparison to a pure etching surface test (etch test) known from the related art, where it is merely possible to check a test volume extending over a depth of approximately 0.5 mm, a significantly larger volume may be evaluated on the basis of the method, respectively using checking device 32.

At least one characteristic value may preferably be ascertained from a number of deviations 22, 24 and thus from the number of material defects 28, 36, which may be used as a quality criterion for producing future components, thus, for example, future turbine disks. This characteristic value may characterize a number of segregations per volume element of blank 10 and/or of subregion 12 or a size distribution of the segregations of blank 10 and/or of subregion 12, for example.

### LIST OF REFERENCE NUMERALS

10 blank
12 subregion
14 unmachined segment
16 tool
18 force curve
20 force sensor
22 deviation
24 deviation
26 target curve
28 material defect
30 force gradient
32 checking device
34 display device
36 material defect

What is claimed is:

1-13. (canceled)

14: A method for checking at least a subregion of a component, the method comprising at least the steps of:
a) providing a blank;
b) producing at least the subregion from the blank by machining the blank using at least one tool and using at least one force sensor to record at least one force curve of at least one force acting during machining on the at least one tool;
c) checking whether there is at least one deviation of the at least one force curve from at least one predetermined target curve, the at least one deviation characterizing at least one material defect contained in an unmachined segment of the subregion.

15: The method as recited in claim 14 wherein step c) is performed during production of the at least one subregion (12) from blank (10) in accordance with step b).

16: The method as recited in claim 14 wherein, in step c), the at least one force curve is compared to at least one further force curve characterizing a machining of at least one further component, and the at least one deviation in the at least one subregion is thereby evaluated, the at least one further component having at least one further material defect that is similar to the at least one material defect and at least one further deviation of the at least one further force curve from the at least one predetermined target curve being present.

17: The method as recited in claim 16 wherein a position of the at least one material defect in the unmachined segment is at least approximately determined by comparing the at least one force curve with the at least one further force curve.

18: The method as recited in claim 16 wherein the at least one deviation in the at least one subregion is evaluated using at least one force gradient of the at least one force curve or of the at least one further force curve.

19: The method as recited in claim 18 wherein the at least one force gradient is time-dependent or location-dependent.

20: The method as recited in claim 18 wherein at least one change in the at least one force gradient effected by the layer-by-layer material removal from the blank during machining is used in order to evaluate the at least one deviation.

21: The method as recited in claim 16 wherein the at least one further force curve is determined before the at least one force curve.

22: The method as recited in claim 14 wherein an artificial neural network implements the checking in step c).

23: The method as recited in claim 14 wherein at least a cutting force acting during the machining on the at least one tool is used as the at least one force.

24: The method as recited in claim 14 wherein a milling cutter or a lathe tool is used as the at least one tool.

25: The method as recited in claim 14 wherein the component is a turbomachine component.

26: A checking device for checking at least a subregion of a component, the checking device comprising:
a connection receiving force-curve sensor signals characterizing at least one force curve of at least one force acting during the machining on the at least one tool, from at least one force sensor upon a production of the at least one subregion from a blank by machining the blank by at least one tool;
the checking device on the basis of the force-curve sensor signals characterizing the at least one force curve, checking whether there is at least one deviation of the at least one force curve from at least one predetermined target curve of the at least one force curve, the at least one deviation characterizing at least one material defect contained in an unmachined segment of the subregion.

27: The checking device as recited in claim 26 further comprising a display device for displaying at least the at least one deviation of the at least one force curve from the at least one predetermined target curve.

28: The checking device as recited in claim 26 wherein the component is a turbomachine component.
